(19) United States
(12) Patent Application Publication
(10) Pub. No.: US 2004/0116546 A1
(43) Pub. Date: Jun. 17, 2004

(54) Direct organic fuel cell proton exchange membrane and method of manufacturing the same

(76) Inventors: John A. Kosek, Danvers, MA (US); Monjid Hamdan, Worcester, MA (US); Anthony B. LaConti, Lynnfield, MA (US); Thomas Menezes, Lowell, MA (US); Vincent D'Agostino, Dix Hills, NY (US)

Correspondence Address: KRIEGSMAN & KRIEGSMAN, 665 Franklin Street, Framingham, MA, 01702, US

(21) Appl. No.: 10/655,051

(22) Filed: Sep. 4, 2003

Related U.S. Application Data
(60) Provisional application No. 60/433,405, filed on Dec. 13, 2002.

(51) Int. Cl. C25D 17/00; H01M 8/10

(52) U.S. Cl. 521/27; 204/252; 429/30

(57) ABSTRACT

A proton exchange membrane well-suited for use in a direct methanol fuel cell. According to one embodiment, the proton exchange membrane is prepared by a process comprising the steps of (a) providing a perfluorocarbon membrane, the perfluorocarbon membrane being non-permeable to water; (b) imbibing the perfluorocarbon membrane with a solution containing a styrene monomer, a divinyl benzene cross-linker, and a benzoyl peroxide activator; (c) heating the imbibed membrane to yield a cross-linked polymer within the membrane; (d) repeating the combination of steps (b) and (c) at least once; and (e) then, sulfonating the cross-linked polymer. According to another embodiment, the membrane is irradiated prior to the imbibing step, thereby rendering the membrane receptive to imbibing, polymerization, crosslinking, and grafting and obviating the need for more than one cycle of steps (b) and (c), as well as permitting step (c) to be performed at a lower temperature.

### CROSS-REFERENCE TO RELATED APPLICATIONS

The present application claims the benefit under 35 U.S.C. 19(e) of U.S. Provisional Patent Application Serial No. 60/433,405, filed Dec. 13, 2002, the disclosure of which is incorporated herein by reference.

### STATEMENT REGARDING FEDERALLY SPONSORED RESEARCH OR DEVELOPMENT

This invention was made with government support under Contract No. DAAL01-98-C-0004 with the Department of Defense. The Government has certain rights in the invention.

### BACKGROUND OF THE INVENTION

The present invention relates generally to fuel cells and relates more particularly to direct organic fuel cell proton exchange membranes.

Fuel cells are electrochemical cells in which a free energy change resulting from a fuel oxidation reaction is converted into electrical energy. Because of their comparatively high inherent efficiencies and comparatively low emissions, fuel cells are presently receiving considerable attention as a possible alternative to the combustion of nonrenewable fossil fuels in a variety of applications.

A typical fuel cell comprises a fuel electrode (i.e, anode) and an oxidant electrode (i.e., cathode), the two electrodes being separated by an ion-conducting electrolyte. The electrodes are connected electrically to a load, such as an electronic circuit, by an external circuit conductor. Oxidation of the fuel at the anode produces electrons that flow through the external circuit to the cathode producing an electric current. The electrons react with an oxidant at the cathode. In theory, any substance capable of chemical oxidation that can be supplied continuously to the anode can serve as the fuel for the fuel cell, and any material that can be reduced at a sufficient rate at the cathode can serve as the oxidant for the fuel cell.

In one well-known type of fuel cell, sometimes referred to as a hydrogen fuel cell, gaseous hydrogen serves as the fuel, and gaseous oxygen, which is typically supplied from the air, serves as the oxidant. The electrodes in a hydrogen fuel cell are typically porous to permit the gas-electrolyte junction to be as great as possible. At the anode, incoming hydrogen gas ionizes to produce hydrogen ions and electrons. Since the electrolyte is a non-electronic conductor, the electrons flow away from the anode via the external circuit, producing an electric current. At the cathode, oxygen gas reacts with hydrogen ions migrating through the electrolyte and the incoming electrons from the external circuit to produce water as a byproduct. The overall reaction that takes place in the fuel cell is the sum of the anode and cathode reactions, with part of the free energy of reaction being released directly as electrical energy and with another part of the free energy being released as heat at the fuel cell.

It can be seen that as long as oxygen and hydrogen are fed to a hydrogen fuel cell, the flow of electric current will be sustained by electronic flow in the external circuit and ionic flow in the electrolyte. Oxygen, which is naturally abundant in air, can easily be continuously provided to the fuel cell. Hydrogen, however, is not so readily available and specific measures must be taken to ensure its provision to the fuel cell. One such measure for providing hydrogen to the fuel cell involves storing a supply of hydrogen gas and dispensing the hydrogen gas from the stored supply to the fuel cell as needed. Another such measure involves storing a supply of an organic fuel, such as methanol, and then reforming or processing the organic fuel into hydrogen gas, which is then made available to the fuel cell. However, as can readily be appreciated, the reforming or processing of the organic fuel into hydrogen gas requires special equipment (adding weight and size to the system) and itself requires the expenditure of energy. Moreover, the storage and handling of gaseous hydrogen presents certain safety hazards.

Accordingly, in another well-known type of fuel cell, sometimes referred to as a direct organic fuel cell, an organic fuel is itself oxidized at the anode. One of the more common organic fuels is methanol although ethanol, propanol, isopropanol, trimethoxymethane, dimethoxymethane, dimethyl ether, trioxane, formaldehyde, and formic acid are also suitable for use. Typically, the electrolyte in such a fuel cell is a solid polymer electrolyte or proton exchange membrane (PEM).

At present, there are two different types of systems that incorporate direct organic fuel cells, namely, liquid feed systems and vapor feed systems. At present, liquid feed systems appear to be preferred over vapor feed systems, due in part to their simplicity (simple and efficient heat management) and their inherent reliability (cell membrane flooded with water). Examples of liquid feed systems are disclosed in the following U.S. patents, all of which are incorporated herein by reference: U.S. Pat. No. 5,992,008, inventor Kindler, issued Nov. 30, 1999; U.S. Pat. No. 5,945,231, inventor Narayanan et al., issued Aug. 31, 1999; U.S. Pat. No. 5,599,638, inventors Surampudi et al., issued Feb. 4, 1997; and U.S. Pat. No. 5,523,177, inventors Kosek et al., issued Jun. 4, 1996.

In a typical liquid feed system, a dilute aqueous solution of the organic fuel (i.e., approximately 3-5 wt % or 0.5-1.5 M organic fuel) is delivered to the fuel cell anode whereupon said aqueous solution diffuses to the active catalytic sites of the anode, and the fuel therein is oxidized. The liquid feed system is typically operated at 60° C.-90° C. although operation at higher temperatures is possible by pressurizing the anode and the fuel supply system. (For operation at temperatures greater than 100° C., cathode pressurization is additionally required.)

Referring now to FIG. 1, there is shown a simplified schematic view of a conventional direct methanol fuel cell, said conventional direct methanol fuel cell being represented generally by reference numeral 11.

Conventional direct methanol fuel cell 11 comprises a proton exchange membrane 13, an anode 15 positioned against one face of proton exchange membrane 13, and a cathode 17 positioned against the opposite face of proton exchange membrane 13. Proton exchange membrane 13 is typically a Nafion® membrane, a co-polymer membrane made of tetrafluoroethylene and perfluorovinylether sulfonic acid that is commercially available from DuPont (Wilmington, Del.). Anode 15, which serves to promote oxidation of the methanol fuel, includes platinum/ruthenium particles mixed with a binder. Cathode 17, which serves to promote reduction of the oxidant, includes platinum black mixed with a binder.

Proton exchange membrane 13, anode 15 and cathode 17 together form a single multi-layer composite structure, which is referred to herein as a membrane electrode assembly.

Fuel cell 11 additionally includes sheets 18-1 and 18-2 of wetproofed carbon fiber paper bonded to the outer faces of anode 15 and cathode 17, respectively, for current collection and mechanical support. A flow distributor 19 is positioned along the outer face of sheet 18-1 and a gas separator 20 is positioned along the outer face of flow distributor 19, flow distributor 19 and gas separator 20 being used to define an anode chamber. A flow distributor 21 is positioned along the outer face of sheet 18-2 and a gas separator 22 is positioned along the outer face of flow distributor 22, flow distributor 21 and separator 22 defining a cathode chamber. The anode chamber is provided with an input port (not shown) for receiving a mixture of methanol and water and is additionally provided with an output port (not shown) for discharging methanol, water and carbon dioxide. The cathode chamber is provided with an input port (not shown) for admitting gaseous oxygen (or air) and is additionally provided with an output port (not shown) for releasing excess oxygen (or air) and water.

Fuel cell 11 further includes an external electrical load 31 connected between sheets 18-1 and 18-2.

During operation, a mixture of methanol and water is admitted into the anode chamber through its input port and is circulated over anode 15. The circulation of the methanol/water mixture over anode 15 causes electrons to be released in the following electrochemical reaction:

Anode: CH₃OH+H₂O→CO₂+6H⁺+6e⁻ (1)

Carbon dioxide produced by the above reaction is then discharged from the anode chamber through its output port, together with any excess methanol/water mixture. (The carbon dioxide is then typically separated from the methanol/water mixture, and the methanol/water mixture is then typically re-circulated to the anode chamber using a pump.)

At the same time the electrochemical reaction described in equation (1) above is occurring, gaseous oxygen (or air) is admitted into the cathode chamber through its input port and is circulated over cathode 17. The circulation of oxygen over cathode 17 causes electrons to be captured in the following electrochemical reaction:

Cathode: 1.50₂+6H⁺+6e⁻→3H₂O (2)

Excess oxygen (or air) and water are then discharged from the cathode chamber through its output port. (The water may be recovered from the effluent air stream by a water/gas separator and/or by a condenser.) The individual electrode reactions described by equations (1) and (2) result in the following overall reaction for fuel cell 11, with a concomitant flow of electrons:

Overall: CH₃OH+1.50₂→CO₂+2H₂O (3)

As can readily be appreciated, many practical applications of direct methanol fuel cells (DMFCs) require the collective output of a plurality of such cells. Consequently, it is common to employ a stack of direct methanol fuel cells arranged in a bipolar series configuration.

One problem that has been observed in direct organic fuel cells of the type described above is that the proton exchange membrane typically used is rather permeable to the organic fuel. As a result, a substantial portion of the organic fuel delivered to the anode has a tendency to permeate through the proton exchange membrane, instead of being oxidized at the anode. The organic fuel permeating through the proton exchange membrane is referred to in the art as crossover. Unfortunately, much of the fuel that crosses over the proton exchange membrane is chemically reacted at the cathode and, therefore, cannot be collected and re-circulated to the anode. This loss of fuel across the proton exchange membrane can amount to as much as 50% of the fuel.

Another complication resulting from crossover is that the organic fuel arriving at the cathode tends to limit the accessibility of the cathode to gaseous oxygen, which must be reduced at the cathode to complement the oxidation of the fuel at the anode. With the accessibility of the cathode thus limited, fuel cell performance is adversely affected.

One approach that has been taken in an attempt to compensate for the above-described inefficiencies attributable to crossover has been simply to increase the size of the fuel cell. However, as can readily be appreciated, such an approach is generally undesirable as it results in a larger, heavier, and more expensive fuel cell. Alternatively, another approach to minimizing crossover has been to modify the proton exchange membrane. In one example of such an approach (Potje-Kamloth et al., “Polymer Coated Oxygen Cathode for Methanol Fuel Cell Application,” Abstract No. 105, Extended Abstracts, Vol. 92-2, Fall Meeting of the Electrochemical Society, Toronto, October 11-16 (1992), which is incorporated herein by reference), there is disclosed an electrochemically polymerized cation-permeable poly(oxyphenylene) film containing carboxylic or sulfonic acid groups on the cathode structure for limiting methanol diffusion to the cathode. Performance plots for O₂ reduction in the presence of such a film exhibited an improvement of 40 mV, as compared to an uncoated cathode.

In another example (Savinell et al., J. Electrochem. Soc., 141, L46 (1994), which is incorporated herein by reference), Nafion® 117 films were imbibed with concentrated H₃PO₄ in an effort to develop a high-temperature (150 to 200° C.) direct methanol fuel cell. Methanol permeability studies showed that methanol crossover was lowered by a combination of higher temperatures and decreased methanol partial pressures. In an alternative approach to developing a high-temperature direct methanol fuel cell (Wainright et al., J. Electrochem. Soc., 142(7), L121 (1995), which is incorporated herein by reference), a polybenzimidazole membrane was imbibed with H₃PO₄.

In yet another example, membranes based on tin mordenite have been investigated. See Rao et al., Solid State Ionics, 72, 334 (1994) and Kjaer et al., “Solid State Direct Methanol Fuel Cells,” in Proceedings of the 26^{th} Intersociety Energy Conversion Engineering Conf., Boston, Mass., p. 542, (August 1991), both of which are incorporated herein by reference. Fuel cells containing such membranes are expected to be operated at 80-100° C.

In still another example (Pu et al., J. Electrochem. Soc., 142(2), L119 (1995), which is incorporated herein by reference), a solid barrier was placed between two Nafion® membranes as a methanol barrier. However, this approach has met with limited success.

In still yet another example (Kovar et al., Paper presented at Fuel Cells for Transportation TOPTEC, Cambridge, Mass., SAE International, Mar. 18-19, 1998, which is incorporated herein by reference), 100% sulfonated polyethersulfone was imbibed into a poly(bisbenzoxazole) base film to yield a membrane exhibiting a methanol transmission rate 11% of that of a Nafion® 117 control membrane.

In even yet another example (Büchi et al., J. Electrochem. Soc., 142, 3044 (1995), which is incorporated herein by reference), divinyl benzene and triallyl cyanurate have been cross-linked in a fluorinated ethylene propylene (FEP) film adapted for use in a H₂/Air proton exchange membrane fuel cell.

### SUMMARY OF THE INVENTION

It is an object of the present invention to provide a novel proton exchange membrane that is well-suited for use in a direct organic fuel cell, such as a direct methanol fuel cell.

It is another object of the present invention to provide a proton exchange membrane of the type described above that overcomes at least some of the drawbacks discussed above in connection with existing proton exchange membranes.

The present invention is based, at least in part, on the discovery that a proton exchange membrane that is well-suited for use in a direct organic fuel cell and that exhibits desirable properties, such as reduced crossover as compared to existing proton exchange membranes, may be obtained by treating a non-water-permeable perfluorocarbon membrane by a process that comprises the steps of imbibing the membrane with a polymerizable monomer and a cross-linker, effecting the cross-linked polymerization of the polymerizable monomer to yield a cross-linked polymer within the membrane, and then sulfonating the cross-linked polymer. The combination of imbibing and cross-linked polymerization steps may be repeated at least once to increase the amount of cross-linked polymer within the membrane. Alternatively, or in addition to the repeated imbibing and polymerization steps, one may irradiate the membrane, prior to any imbibing, to render the membrane more receptive to the imbibing and cross-linked polymerization steps, as well as to render the membrane receptive to the grafting of the cross-linked polymer to the membrane. In those instances in which the aforementioned irradiating step is performed, the membrane need not be a perfluorocarbon membrane, but rather, may be a polymer, copolymer or terpolymer membrane formed from hydrocarbon, halogenated or perhalogenated monomers.

Therefore, according to a first embodiment of the invention, there is provided a proton exchange membrane well-suited for use in a direct organic fuel cell, such as a direct methanol fuel cell, said proton exchange membrane being prepared by a process comprising the steps of (a) providing a perfluorocarbon membrane, said perfluorocarbon membrane being non-permeable to water; (b) imbibing said perfluorocarbon membrane with a polymerizable monomer and a cross-linker; (c) effecting the cross-linked polymerization of said polymerizable monomer to yield a cross-linked polymer within said perfluorocarbon membrane; (d) preferably repeating the combination of steps (b) and (c) at least once; and (e) then, sulfonating the cross-linked polymer.

The polymerizable monomer preferably is, but is not limited to, a styrene monomer, and the cross-linker preferably is, but is not limited to, divinylbenzene. The styrene monomer and divinylbenzene may be introduced into the perfluorocarbon membrane by soaking the membrane in a solution containing styrene and divinylbenzene. Preferably, such a solution contains about 1-8%, by weight, divinylbenzene with respect to styrene. Such a solution preferably also includes about 1%, by weight, benzoyl peroxide as an activator. Preferably, after imbibing the membrane with said solution, the imbibed film is heated to a temperature of about 60-90° C. for a period of about 16 hours to effect fully the cross-linked polymerization. Preferably, the combination of the imbibing and the cross-linked polymerization steps are then repeated one or more times, more preferably one to four times, with the proportion of divinylbenzene to styrene increasing in the later repetitions. After each polymerization step, excess polystyrene is preferably removed. Preferably, this is done by immersing the sample in a CH₃Cl bath at room temperature for 1 to 24 hours. Sulfonation of the membrane is preferably performed by immersing the membrane in ClSO₃H/CH₃Cl solution for about 72 hours and then boiling the previously immersed membrane in distilled water.

According to a second embodiment of the invention, there is provided a proton exchange membrane well-suited for use in a direct organic fuel cell, such as a direct methanol fuel cell, said proton exchange membrane being prepared by a process comprising the steps of (a) providing a non-water-permeable membrane, said non-water-permeable membrane being a polymer, copolymer or terpolymer membrane formed from hydrocarbon, halogenated or perhalogenated monomers; (b) irradiating said non-water-permeable membrane so as to render said non-water-permeable membrane receptive to the imbibing, crosslinking, polymerization and grafting of a polymer thereto; (c) imbibing said non-water-permeable membrane with a polymerizable monomer and a cross-linker; (d) effecting the cross-linked polymerization of said polymerizable monomer and the grafting of said cross-linked polymer to said non-water-permeable membrane; and (e) then, sulfonating the cross-linked polymer.

The aforementioned irradiating step may comprise, for example, irradiating the non-water-permeable membrane with an electron beam. The imbibing step may be performed immediately after the irradiating step, or the membrane may be stored for up to 3 months in a cold, inert atmosphere after the irradiating step and prior to the imbibing step. The imbibing step may be conducted at a low temperature (55° C.), with the imbibed membrane thereafter cured at 70-80° C. in an air oven.

According to a third embodiment of the invention, there is provided a proton exchange membrane well-suited for use in a direct organic fuel cell, said proton exchange membrane being prepared by a process similar to that described in the first embodiment or the second embodiment described above, except that (a) the membrane is first imbibed with monomer and activator so that the monomer polymerizes within said membrane and (b) subsequently, the polymer is crosslinked by the addition of a crosslinking agent to said membrane.

The present invention is also directed to methods for preparing the proton exchange membranes described above and is additionally directed to membrane electrode assemblies incorporating the above-described proton exchange membranes and fuel cells, particularly direct methanol fuel cells, incorporating the above-described proton exchange membranes.

For purposes of the present specification and claims, it is to be understood that certain terms used herein, such as “on,” “over,” and “in front of,” when used to denote the relative positions of two or more components of a fuel cell, are used to denote such relative positions in a particular orientation and that, in a different orientation, the relationship of said components may be reversed or otherwise altered.

Additional objects, as well as features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a simplified schematic view of a conventional direct methanol fuel cell, illustrating its operation;

FIG. 2 is a graphic depiction of the polarization scans described in Example 5;

FIG. 3 is a graphic depiction of the polarization scans described in Example 9 obtained using 0.5 M methanol;

FIG. 4 is a graphic depiction of the polarization scans described in Example 9 obtained using 1.0 M methanol;

FIG. 5 is a graphic depiction of the polarization scans described in Example 10 obtained using 0.5 M methanol;

FIG. 6 is a graphic depiction of the polarization scans described in Example 10 obtained using 1.0 M methanol;

FIG. 7 is a graphic depiction of the methanol permeability measurements for 0.5 M methanol described in Example 10; and

FIG. 8 is a graphic depiction of the methanol permeability measurements for 1.0 M methanol described in Example 10.

### DETAILED DESCRIPTION OF PREFERRED EMBODIMENTS

As noted above, the present invention is based, in part, on the unexpected discovery that, by employing the methods of the present invention, one can prepare proton exchange membranes that are well-suited for use in direct methanol fuel cells and that exhibit many desirable properties, such as reduced methanol crossover as compared to a Nafion® 117 (polytetrafluoroethylene and perfluorovinylether sulfonic acid copolymer) membrane.

According to a first embodiment of the invention, the preparation of a direct methanol fuel cell proton exchange membrane comprises imbibing a non-water-permeable perfluorocarbon membrane with a polymerizable monomer and a cross-linker; effecting the cross-linked polymerization of said polymerizable monomer; repeating the imbibing and cross-linked polymerization steps one or more times; and then, sulfonating the cross-linked polymer.

More specifically, the above-described perfluorocarbon membrane may comprise a fluorinated ethylene propylene (FEP) film, a polytetrafluoroethylene (PTFE) film or the like. Preferably, the perfluorocarbon membrane has a thickness of about 0.051 to 0.127 mm.

The polymerizable monomer preferably is, but is not limited to, a styrene monomer, and the cross-linker preferably is, but is not limited to, divinylbenzene. The styrene monomer and divinylbenzene may be introduced into the perfluorocarbon membrane by soaking the membrane in a solution containing styrene and divinylbenzene. Preferably, such a solution contains about 1-8%, by weight, divinylbenzene with respect to styrene. Such a solution preferably also includes about 1%, by weight, benzoyl peroxide as an activator. Preferably, after imbibing the membrane with said solution, the imbibed film is heated to a temperature of about 60-90° C. for a period of about 16 hours to effect fully the cross-linked polymerization. Preferably, the combination of the imbibing and the cross-linked polymerization steps are then repeated one or more times, more preferably one to four times, with the proportion of divinylbenzene to styrene increasing in the later repetitions. After each polymerization step, excess polystyrene is preferably removed. Preferably, this is done by immersing the sample in a CH₃Cl bath at room temperature for 1 to 24 hours. Sulfonation of the membrane is preferably performed by immersing the membrane in ClSO₃H/CH₃Cl solution for about 72 hours and then boiling the previously immersed membrane in distilled water.

According to a second embodiment of the invention, the preparation of a direct methanol fuel cell proton exchange membrane comprises irradiating a non-water-permeable polymer, copolymer or terpolymer membrane formed from hydrocarbon, halogenated (in particular fluorinated) or perhalogenated (in particular perfluorinated) monomers; imbibing the irradiated membrane with a polymerizable monomer and a cross-linker; effecting the cross-linked polymerization of said polymerizable monomer and the grafting of said cross-linked polymer to said membrane; and then, sulfonating the cross-linked polymer.

Preferably, the non-water-permeable polymer, copolymer or terpolymer membrane is selected from polyethylene (PE), polytetrafluoroethylene (PTFE), polyhexafluoropropylene (HEP), tetrafluoroethylene-hexafluoropropylene copolymer (FEP), tetrafluoroethylene-propylene copolymer, tetrafluoroethylene-ethylene copolymer (ETFE), hexafluoropropylene-propylene copolymer, hexafluoropropylene-ethylene copolymer, polyvinylidene fluoride (PVDF), vinylidene fluoride tetrafluoroethylene copolymer (PVDF-TFE), vinylidene fluoride hexafluoropropylene copolymer (PVDF-HFP or “Kynar-Flex”), polyvinyl fluoride, tetrafluoroethylene-perfluoroalkyl vinyl ether copolymer, polyvinylidene-hexafluoropropylene copolymer, chlorotrifluoroethylene-ethylene copolymer, chlorotrifluoroethylene-propylene-propylene copolymer, perfluoroalkoxy copolymer, polychoroethylene, polyvinyl fluoride, tetrafluoroethylene-perfluoroalkyl vinyl ether copolymer, or perfluoroalkoxy copolymer (PFA). Tetrafluoroethylene-hexafluoropropylene copolymer is particularly preferred.

Preferably, the non-water-permeable membrane has a thickness of about 0.051 to 0.127 mm.

The irradiating step of the second embodiment may comprise, for example, irradiating the membrane with a suitable form of radiation. Typical radiation doses range from about 0.1 kGray to about 500 kGray, with a preferred dose being in the range of about 20-50 kGray. The form of radiation may be an electron beam, gamma rays, x-rays, UV light, plasma irradiation, or beta particles. Preferably, the radiation used is beta particles. The imbibing step of the second embodiment may be performed immediately after the irradiating step. Alternatively, subsequent to the irradiating step, but prior to the imbibing step, the membrane may be stored for up to 3 months in a cold, inert atmosphere.

The imbibing step of the second embodiment preferably comprises immersing the membrane in a solution of a polymerizable monomer and a cross-linker at a low temperature (about 35° C. to 80° C.) for about 3 to 60 hours. A preferred temperature range is 55° C. to 60° C., with a preferred time being about 15 to 18 hours. Preferably, the polymerizable monomer is selected from styrene; trifluorostyrene; alphamethylstyrene; alpha,beta-dimethylstyrene; alpha,beta,beta-trimethylstyrene; ortho-methylstyrene; meta-methylstyrene; and para-methylstyrene. The cross-linker is preferably divinylbenzene or triallylcyanurate. The solution also preferably contains about 1%, by weight, benzoyl peroxide as an activator. The imbibed membrane is then removed from the solution containing the polymerizable monomer and the cross-linker and is then cured at 70-80° C. in an air oven. The sulfonation step for membranes of the second embodiment is the same as that for membranes of the first embodiment.

Some of the advantages to the radiation-grafting technique of the second embodiment as compared to the multiple polymerization technique of the first embodiment are that (i) the radiation-grafting technique allows for processing of the membrane at lower temperatures than is possible with the multiple polymerization technique; (ii) the radiation-grafting technique requires only one imbibing/polymerization cycle and, therefore, reduces the processing time considerably (by as much as 80% in certain instances) and allows for more membranes to be processed in a single batch.

It should be understood, however, that the irradiation step of the second embodiment may also be added to the above-described multiple polymerization technique.

According to a third embodiment of the invention, there is provided a proton exchange membrane well-suited for use in a direct organic fuel cell, said proton exchange membrane being prepared by a process similar to that described in the first embodiment described above or the second embodiment described above, except that, instead of imbibing the membrane with the polymerizable monomer and the cross-linker at one time, the membrane is first imbibed with the polymerizable monomer and an activator; then, polymerization of said polymerizable monomer within said membrane is effected; then, the cross-linker is added to the membrane; and then, the polymer is crosslinked by said cross-linker.

The proton exchange membranes of the present invention may be employed in direct organic (e.g., methanol) fuel cells in the same fashion as conventional proton exchange membranes.

The following examples are provided for illustrative purposes only and are in no way intended to limit the scope of the present invention:

### EXAMPLE 1

### Generalized Technique for Membrane Preparation Using Multiple Polymerization Cycles

Styrene-divinyl benzene (S/DVB) solutions containing 1, 3, 5, and 8 weight percent divinylbenzene (DVB), respectively, with respect to styrene and 1 wt % benzoyl peroxide, as an activator, were prepared. FEP films were placed in glass containers filled with S/DVB solutions in the above concentrations at room temperature. The containers were then sealed to prevent atmospheric exposure. The sealed containers were then heated in an oil bath at a temperature of 60° C.-90° C., depending on film type, for a period of 16+hours or until total polymerization occurred. The sealed containers were then removed from the oil bath and allowed to cool to room temperature.

Excess polystyrene (i.e., that which was not cross-linked within the FEP film) was then removed from the FEP film by immersing the sample in a CH₃Cl bath at room temperature. The length of the removal process depended on the amount of excess polystyrene and lasted from 1 to 24 hours.

All FEP films were subjected to multiple (up to 5) polymerization cycles. During the first such cycle, cross-linking occurred mainly on the surface of the film. Subsequent cycles were then performed to promote cross-linking within the film. For each such subsequent polymerization cycle, the excess polystyrene was removed, and the films were placed in a new solution of S/DVB. After all of the polymerization cycles were completed, the excess polystyrene was removed.

After the removal of excess polystyrene, the films were immersed in a ClSO₃H/CH₃Cl solution for a period of 72 hours. (An excess amount of ClSO₃H was used. The amount of ClSO₃H was calculated based on the amount needed to neutralize the ethanol and water stabilizer in the CH₃Cl per 100 grams of CH₃Cl. In this case, 10%-30% ClSO₃H/balance CH₃Cl by volume was used.) Next, the film samples were carefully removed from the chlorosulfonic acid solution using inert plastic tongs and placed into a 4-liter beaker of distilled water at room temperature. The film-containing beaker of distilled water was then covered and brought to a rapid boil. After a period of time, 25 ml samples of the boiling water were taken, allowed to cool to room temperature, and then tested for the presence of Cl⁻ ions using one or two drops of AgNO₃ solution. If Cl⁻ ions were found in the water sample, the film samples were placed in another previously heated beaker of distilled water. This procedure was repeated until the test for Cl⁻ ions was negative.

### EXAMPLE 2

### Specific Membranes Prepared Using Multiple Polymerization Cycles

Several series of sulfonated polystyrene FEP membranes were prepared in accordance with the general technique described above in Example 1. A first group of membranes, each membrane in said group having a thickness of 0.051 mm, is described below in Table I. A second group of membrane, each membrane in said group having a thickness of 0.127 mm, is described below in Table II. In both the first and second groups of membranes, FEP films were initially polymerized Using solutions containing 3, 5, or 8 weight % DVB with respect to styrene, and then subsequently Using solutions containing 1 weight % DVB with respect to styrene.

TABLE I

| Sample | Wt % DVB | | Final Wt (g) at | |
|---|---|---|---|---|
| Membrane | Per Polymer. | Initial Wt | Completion of | Wt % S/DVB |
| No. | Cycle | (g) | Polymerization | in Base Film |
| 1 | 3, 1, 1, 1 | 1.385 | 1.547 | 11.7 |
| 2 | 3, 1, 1, 1, 1 | 1.415 | 1.708 | 20.7 |
| 3 | 3, 1, 1, 1, 1, 1 | 1.392 | NA | Fail |
| 4 | 5, 1, 1, 1 | 1.422 | 1.621 | 14 |
| 5 | 5, 1, 1, 1, 1 | 1.429 | 2.314 | 61.9 |
| 6 | 5, 1, 1, 1, 1, 1 | 1.399 | NA | Fail |
| 7 | 8, 1, 1, 1 | 1.385 | 1.668 | 20.4 |
| 8 | 8, 1, 1, 1, 1 | 1.398 | 1.665 | 19.1 |
| 9 | 8, 1, 1, 1, 1, 1 | 1.454 | NA | Fail |

TABLE II

| Sample | Wt % DVB | | Final Wt (g) at | |
|---|---|---|---|---|
| Membrane | Per Polymer. | Initial Wt | Completion of | Wt % S/DVB |
| No. | Cycle | (g) | Polymerization | in Base Film |
| 10 | 3, 1, 1, 1 | 3.44 | 4.977 | 44.7 |
| 11 | 3, 1, 1, 1, 1 | 3.427 | 6.101 | 78.0 |
| 12 | 3, 1, 1, 1, 1, 1 | 3.382 | NA | Fail |
| 13 | 5, 1, 1, 1 | 3.55 | 3.942 | 11 |
| 14 | 5, 1, 1, 1, 1 | 3.527 | 5.326 | 51 |
| 15 | 5, 1, 1, 1, 1, 1 | 3.607 | NA | Fail |
| 16 | 8, 1, 1, 1 | 3.444 | 3.924 | 13.9 |
| 17 | 8, 1, 1, 1, 1 | 3.435 | 5.639 | 64.2 |
| 18 | 8, 1, 1, 1, 1, 1 | 3.462 | NA | Fail |

AS can be seen, those membranes prepared using three subsequent 1 weight % DVB cycles exhibited superior film integrity. By contrast, those membranes prepared using four subsequent 1 weight % DVB cycles began to expand in size, and those membranes prepared using five subsequent 1 weight % DVB cycles experienced failure due to pinhole development, loss of film integrity due to expansion, and wrinkle formation during film processing.

A third group of membranes, each membrane in said group having a thickness of 0.051 mm, is described below in Table III, and a fourth group of membranes, each membrane in said group having a thickness of 0.127 mm, is described below in Table IV. In both the third and fourth groups of membranes, the FEP films were subjected to polymerization treatments in which a solution containing 1 weight % DVB with respect to styrene was used for the first three or more polymerization cycles and a solution containing 3, 5 or 8 wt % DVB with respect to styrene was used for the final polymerization cycle.

TABLE III

| Sample | Wt % DVB | | Final Wt (g) at | |
|---|---|---|---|---|
| Membrane | Per Polymer. | Initial Wt | Completion of | Wt % S/DVB |
| No. | Cycle | (g) | Polymerization | in Base Film |
| 19 | 1, 1, 1, 3 | 1.412 | 1.942 | 37.5 |
| 20 | 1, 1, 1, 1, 3 | 1.342 | 4.942 | 268.3 |
| 21 | 1, 1, 1, 1, 1, 3 | 1.333 | NA | Fail |
| 22 | 1, 1, 1, 5 | 1.382 | 1.630 | 17.9 |
| 23 | 1, 1, 1, 1, 5 | 1.342 | 3.316 | 147.1 |
| 24 | 1, 1, 1, 1, 1, 5 | 1.360 | NA | Fail |
| 25 | 1, 1, 1, 8 | 1.374 | 1.510 | 9.9 |
| 26 | 1, 1, 1, 1, 8 | 1.370 | 3.814 | 178.0 |
| 27 | 1, 1, 1, 1, 1, 8 | 1.454 | NA | Fail |

TABLE IV

| Sample | Wt % DVB | | Final Wt (g) at | |
|---|---|---|---|---|
| Membrane | Per Polymer. | Initial Wt | Completion of | Wt % S/DVB |
| No. | Cycle | (g) | Polymerization | in Base Film |
| 28 | 1, 1, 1, 3 | 3.321 | 4.279 | 28.8 |
| 29 | 1, 1, 1, 1, 3 | 3.371 | 7.427 | 120.3 |
| 30 | 1, 1, 1, 1, 1, 3 | 3.539 | NA | Fail |
| 31 | 1, 1, 1, 5 | 3.413 | 4.052 | 18.7 |
| 32 | 1, 1, 1, 1, 5 | 3.360 | 6.646 | 97.8 |
| 33 | 1, 1, 1, 1, 1, 5 | 3.483 | NA | Fail |
| 34 | 1, 1, 1, 8 | 3.466 | 3.856 | 11.3 |
| 35 | 1, 1, 1, 1, 8 | 3.438 | 4.690 | 36.4 |
| 36 | 1, 1, 1, 1, 1, 8 | 3.434 | NA | Fail |

It can be seen, by comparing Table I with Table III and by comparing Table II with Table IV, that initially using a low wt % DVB solution for a number of cycles and thereafter using a high Wt % DVB solution resulted in the cross-linked polystyrene being introduced more uniformly into The center of the base film than was the case where the reverse order was employed.

### EXAMPLE 3

### Transport and Physical/Chemical Properties of Specific Membranes

All of the membranes of Tables I through IV that were prepared using three 1 wt % polymerization cycles were tested for the following transport and physical/chemical properties: ion-exchange capacity (IEC), resistivity, water content (H₂O wt %), and methanol permeability. Details of such testing are provided below.

IEC and Water-Content: The membranes were immersed in distilled water and boiled for a period of 30 minutes. The membranes were then placed in a solution of 1.5N H₂SO₄ at room temperature and soaked for a period of 30 minutes. This was repeated three separate times to ensure proper H⁺ ion exchange into the membrane. Next, the membranes were rinsed free of acid and then placed into separate capped test tubes, each filled with a saturated solution of NaCl. The salt solution was then heated to 90° C. for a period of three hours. The membranes, now in the Na⁺ form, were then removed from the salt solution, rinsed with distilled water, blotted to remove excess water and measured for a wet weight and thickness. While in the Na⁺ form, the membranes were dried in an air oven at a temperature of 100° C. for 1 hour. The dry weight and thickness of the membranes were then measured and the percent water content calculated. Next, the salt solutions were titrated with 0.1 N NaOH to a phenolphthalein endpoint and IEC_{dry} (meq/gram dry membrane) values were calculated.

Methanol permeability: The methanol permeability for each membrane was measured by placing a Pt-black gas diffusion electrode along one side of the sample membrane and mounting the membrane in test hardware in which the membrane separated gas and liquid compartments within the hardware. An aqueous methanol solution (1.0 M) was introduced into the liquid-side compartment, and pure O₂ was passed through the gas compartment. The O₂ flowing across the Pt electrode reacted with the permeating alcohol to oxidize it to CO₂. The detection of one mole of CO₂ was equivalent to one mole of methanol permeating through the membrane via the following equation:

CH₃OH+3/2 O₂→CO₂+2H₂O

The ensuing CO₂ was measured using a Vaisala Model GMM 12 NDIR CO₂ detector to indicate the quantity of methanol permeating through the membrane. The value of methanol permeation was normalized for area and time (mol CH₃OH min⁻¹ cm⁻²). This test provided an indication of the rate of methanol crossover at room temperature and open circuit (no current flow) conditions.

Ionic Conductivity/Resistivity: Transverse ionic conductivity measurements were performed on all membranes samples. Prior to ionic conductivity measurements, the membrane samples were exchanged into the H⁺ form by means of multiple exchanges in 1.5N H₂SO₄. To measure the ionic conductivity, the membrane samples were placed in a die consisting of platinum-plated niobium/stainless steel plates. The sample size tested was 25.0 cm². Prior to assembling in the measuring device, platinum black electrodes were placed on each side of the membrane sample to form a membrane-electrode assembly (MEA). To ensure complete contact during the resistivity measurement, the MEA was compressed at 100 to 500 psi between the two platinum-plated niobium/stainless steel plates. The resistance of each membrane was determined with a 1000-Hertz, low-current (1 to 5 A) bridge, four-point probe resistance measuring device and converted to conductivity by:

Conductivity=L/(R×A)

where R is the resistance, L is the sample thickness (wet), and A is the area of the sample. Measurements were converted to Specific Resistivity by:

Specific Resistivity=L/Conductivity

In addition to testing the above-identified membranes, the following membranes were also tested for comparative purposes under similar conditions: (i) a Nafion® 117 membrane; (ii) a commercially available cation-exchange membrane (obtained from Pall-RAI), which we then modified through a single polymerization cycle using 3 wt % DVB, followed by sulfonation; (iii) a commercially available cation-exchange membrane (obtained from Pall-RAI), which we then modified through a single polymerization cycle using 5 wt % DVB, followed by sulfonation; and (iv) a commercially available cation-exchange membrane (obtained from Pall-RAI), which we then modified through a single polymerization cycle using 8 wt % DVB, followed by sulfonation. The results of the above-described testing are provided below in Table V.

TABLE V

| | | | | | | | MeOH |
|---|---|---|---|---|---|---|---|
| | | | | | | | Permeab. |
| Sample | Film Type | | | | | | (mol |
| Membrane | & | Wt % DVB | Wt % | Resistivity | H₂O | IEC | MeOH |
| No. | Thickness | per cycle | S/DVB | (Ohm · cm) | (Wt %) | (meq/g) | min⁻¹ cm⁻²) × 10⁶ |
| 1 | FEP | 3, 1, 1, 1 | 11.7 | 130.8 | 17 | 0.704 | Below |
| | 0.051 mm | | | | | | detection |
| | | | | | | | limit |
| 4 | FEP | 5, 1, 1, 1 | 14 | 81.5 | 22 | 0.797 | 0.7 |
| | 0.051 mm | | | | | | |
| 7 | FEP | 8, 1, 1, 1 | 20.4 | 69.8 | 25.1 | 1.056 | 0.81 |
| | 0.051 mm | | | | | | |
| 10 | FEP | 3, 1, 1, 1 | 44.7 | 187.8 | 25.9 | 0.840 | 0.76 |
| | 0.127 mm | | | | | | |
| 13 | FEP | 5, 1, 1, 1 | 11 | 211 | 17.6 | 0.592 | Below |
| | 0.127 mm | | | | | | detection |
| | | | | | | | limit |
| 16 | FEP | 8, 1, 1, 1 | 13.9 | 138.9 | 19.6 | 0.707 | 0.76 |
| | 0.127 mm | | | | | | |
| 19 | FEP | 1, 1, 1, 3 | 37.5 | 40.4 | 31.2 | 1.417 | 0.76 |
| | 0.051 mm | | | | | | |
| 22 | FEP | 1, 1, 1, 5 | 17.9 | 120.6 | 29.1 | 1.063 | 0.76 |
| | 0.051 mm | | | | | | |
| 25 | FEP | 1, 1, 1, 8 | 9.9 | 887.3 | 9.8 | 0.562 | 0.76 |
| | 0.051 mm | | | | | | |
| 28 | FEP | 1, 1, 1, 3 | 28.8 | 64.9 | 29.5 | 1.290 | 1.53 |
| | 0.127 mm | | | | | | |
| 31 | FEP | 1, 1, 1, 5 | 18.7 | 60.3 | 20.9 | 0.974 | 0.76 |
| | 0.127 mm | | | | | | |
| 34 | FEP | 1, 1, 1, 8 | 11.3 | 290.2 | 14.7 | 0.451 | Below |
| | 0.127 mm | | | | | | detection |
| | | | | | | | limit |
| 37 | RAI | 3 | 36.2 | 25.1 | 37.4 | 2.158 | 6.89 |
| | 0.061 mm | | | | | | |
| 38 | RAI | 5 | 20 | 35.2 | 30.5 | 1.842 | 6.35 |
| | 0.061 mm | | | | | | |
| 39 | RAI | 8 | 5.1 | 49.2 | 24 | 1.171 | 6.12 |
| | 0.061 mm | | | | | | |
| 40 | Nafion | NA | NA | 23.4 | 36 | 0.909 | 8.42 |
| | 117 | | | | | | |

As can be seen from Table V, all of the membranes prepared using multiple polymerization cycles exhibited low methanol permeability rates as compared to the Nafion® 117 membrane. In addition, those membranes that were prepared using three 1 wt % polymerization cycles followed by a higher wt % cycle generally exhibited lower resistivity and higher IECs than those films subject to a higher wt % cycle followed by three 1 wt % cycles.

With respect to the modified Pall-RAI membranes (which were prepared using a single polymerization cycle), methanol permeability was about 75% that of the Nafion® 117 membrane and significantly higher than that observed for the membranes prepared using multiple polymerization cycles.

### EXAMPLE 4

### Scanning Electron Microscope (SEM) Studies

A sample was taken from each of membrane nos. 19 and 31 for scanning electron microscopy (SEM) examination. For each sample, a thin section of the membrane was cut out, mounted and placed in an SEM, and a sulfur dot map was performed to observe the sulfur distribution across the sample. A sulfur distribution was chosen because sulfonic acid groups contain the active proton-conducting groups in the membrane.

The sample derived from membrane no. 19 (the 0.051 mm membrane) showed a more uniform sulfur distribution than the sample derived from membrane no. 31 (the 0.127 mm membrane). In particular, the sample derived from membrane no. 31 showed a higher sulfur concentration near its edges and less sulfur in its center than the sample derived from membrane no. 19. This difference may be attributable to the method of processing, to the inability of chlorosulfonic acid to completely penetrate into the middle of the 0.127 mm membrane or to a higher concentration of cross-linked polystyrene near the membrane surfaces.

### EXAMPLE 5

### Fuel Cell Testing

A pair of membrane-electrode assemblies was fabricated using 8 mg/cm² Pt—Ru as the anode catalysts, 8 mg/cm² Pt black as the cathode catalysts and either membrane no. 19 or membrane no. 31 as the proton exchange membranes. In addition, an analogous MEA was fabricated using a Nafion® 117 membrane as the proton exchange membrane. No difficulties were encountered bonding the catalysts directly to membrane nos. 19 and 31. The active cell areas were 46 cm². The MEAs were placed in standard direct methanol fuel cell hardware and tested at 60° C. using 1.0 M methanol/water as the anode feed and pure O₂ at 310 kPa as the cathode feed. Polarization scans from open circuit to 300 mA/cm² were run in all cases. Methanol crossover was measured while holding the current density constant at 100 mA/cm² and at open circuit.

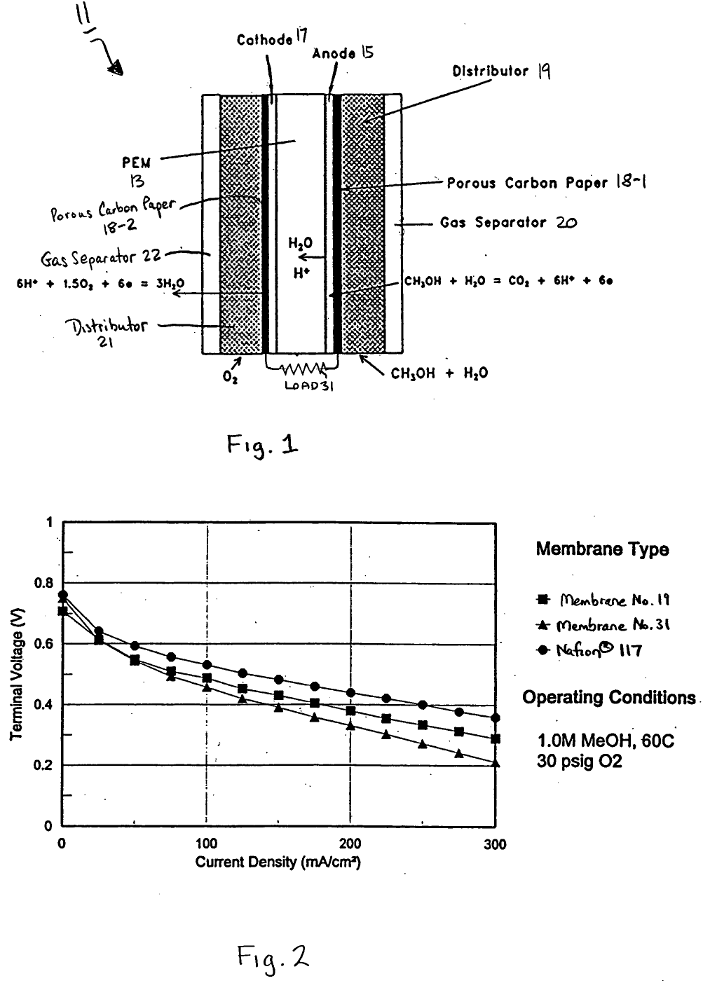

FIG. 2 depicts the polarization scans obtained with all three of the above-described MEAs. As can be seen, the best performance was obtained using the MEA containing the Nafion® 117 membrane, followed by the MEA containing membrane no. 19, which was within 86-92% (over the range 0-200 mA/cm²) of the MEA containing the Nafion® 117 membrane, and then by the MEA containing membrane no. 31, which was within 75 to 86% (over the range 0-200 mA/cm²) of the MEA containing the Nafion® 117 membrane.

Methanol crossover for the various membranes described above was measured at open-circuit conditions and at 100 mA/cm² using an operating direct methanol fuel cell at 60° C. The data from this testing is summarized below in Table VI.

TABLE VI

Crossover Rates
(moles CH₃OH · min⁻¹ · cm⁻²)
Measured at

| Membrane | Open Circuit | 100 mA/cm² |
|---|---|---|
| Membrane No. 19 | 4.85 × 10⁻⁶ | 2.26 × 10⁻⁶ |
| Membrane No. 31 | 2.26 × 10⁻⁶ | 1.59 × 10⁻⁶ |
| Nafion ® 117 | 5.13 × 10⁻⁶ | 3.99 × 10⁻⁶ |

As can be seen, at open circuit, the crossover of membrane no. 31 was 44% of that for a Nafion® 117 membrane under the same conditions. The crossover data, at open circuit, obtained for membrane no. 19 was higher than that for membrane no. 31. All crossover values measured in the fuel cell hardware are higher than those presented previously in Table V. It is suspected that the higher values are due to increased crossover at 60° C., as opposed to the ambient-temperature measurements of Table V.

In addition to providing high methanol exclusion and high direct methanol fuel cell performance, the above-described membranes are estimated to cost about $149/m² to fabricate whereas a Nafion® 117 membrane has a cost of $904/m².

### EXAMPLE 6

### Membrane Preparation Using Radiation Grafting

Fluorinated ethylene propylene (FEP) films having dimensions of 10 cm×10 cm×0.127 mm were placed in polypropylene bags. Next, the air inside the propylene bags was displaced with nitrogen. The FEP films were then irradiated using a 20 kGray (2 MRad) dose. The irradiated FEP films were then impregnated with polystyrene in the following manner: First, the films were removed from the bags, weighed quickly (to avoid reactions between the free radicals in the irradiated films and atmospheric oxygen) and positioned between reusable screens. The films were then immersed in a solution consisting of 50% toluene and 50% S/DVB (1 to 3% DVB:99% styrene) by volume in a 150 ml reaction vessel. One-half percent benzoyl peroxide (based on the amount of S/DVB in solution) was added as an initiator. The vessel containing the films and the solution was Then immersed in a water bath at 55° C. for periods of time ranging from 10 to 16 hours. After this Time, the films were removed from the solution and rinsed with chloroform. They were subsequently Air dried, followed by drying at 60° C. in an oven for 2 hours. After cooling to room temperature, the Films were then re-weighed to determine the total weight gain. The weight percentage gain of cross-linked polystyrene in each of the films is shown below in Table VII.

TABLE VII

| | | | |
|---|---|---|---|
| | | | % Wt Gain of |
| | DVB per Cycle | Processing Time of | S/DVB (based on |
| Sample No. | (Wt %) | Cycle (Hours) | initial film weight) |

FEP - 0.127 mm (Variable DVB Concentration)

| | | | |
|---|---|---|---|
| 41 | 1.5 | 16 | 14.4 |
| 42 | 3.0 | 16 | 14.9 |
| 43 | 5.0 | 16 | 8.4 |
| 44 | 8.0 | 16 | 5.3 |

FEP - 0.127 mm (Variable Processing Time)

| | | | |
|---|---|---|---|
| 45 | 1.0 | 10 | 10.7 |
| 46 | 1.0 | 12 | 11.6 |
| 47 | 1.0 | 14 | 14.1 |
| 48 | 1.0 | 16 | 16.4 |

To form proton exchange membranes from the above-described films, the films were sulfonated in 10% chlorosulfonic acid solution for 16 hours or in 5% or 10% chlorosulfonic acid solution for 24 hours. Upon completion of the sulfonation process, the films were hydrolyzed in boiling water, and exchanged with 1.5 N sulfuric acid into the acid (H⁺) form. Those membranes that were prepared using sulfonation at the lower chlorosulfonic acid concentrations exhibited a slight improvement in their ion-exchange capacities.

### EXAMPLE 7

### Size Scale-Up

Of the proton exchange membranes obtained in the previous example, those derived from film sample nos. 47, 48, 41 and 42 exhibited the best overall film properties, i.e., low specific resistivity, high IEC, low methanol permeation, and fuel cell performance comparable to Nafion® 117 membrane. Accordingly, these samples were chosen for fabrication in a scaled-up process in which the membranes were processed in large 5 liter vessels having the capacity to produce 20 or 25 (23 cm×25 cm) sheets of membrane in a single run. A comparison of weight percentage gains in a small batch versus scaled-up processes of the selected membranes are shown in Table VIII.

TABLE VIII

| | | | |
|---|---|---|---|
| | | | % Wt Gain of |
| | DVB per Cycle | Processing Time of | S/DVB (Based on |
| Sample No. | (Wt %) | Cycle (Hours) | initial film weight) |

FEP - 0.127 mm (Small-Batch Fabrication)

| | | | |
|---|---|---|---|
| 47 | 1.0 | 14 | 14.1 |
| 48 | 1.0 | 16 | 16.4 |
| 41 | 1.5 | 16 | 14.4 |
| 42 | 3.0 | 16 | 14.9 |

FEP - 0.127 mm (Large-Batch Fabrication)

| | | | |
|---|---|---|---|
| 49 | 1.0 | 14 | 15.8 |
| 50 | 1.0 | 16 | 15.1 |
| 51 | 1.5 | 16 | 14.1 |
| 52 | 3.0 | 16 | 10.1 |

### EXAMPLE 8

### Physical Characterization and Performance Tests

The physical characteristics of various membranes obtained using the radiation-grafting technique present invention were measured and are summarized below in Table IX.

TABLE IX

| | | | % Area | | |
|---|---|---|---|---|---|
| | Thickness | | Increase | Physical Characteristics | |
| | (mil) | | (dry to | Before | |
| Sample | Dry | Wet | wet) | Boiling | After Boiling |
| 53 (FEP | 2.9 | 3.1 | 51.5 | Tensile | Tensile |
| 0.051 | | | | strength ≅ | strength ≅ |
| mm) | | | | Nafion ® 117 | Nafion ® 117 |
| 54 (FEP | 3.6 | 4.2 | 30.6 | Tensile | Tensile |
| 0.076 | | | | strength ≅ | strength ≅ |
| mm) | | | | Nafion ® 117 | Nafion ® 117 |
| 55 (FEP | 7.5 | 9.0 | 34.6 | Tensile | Tensile |
| 0.127 | | | | strength > | strength > |
| mm) | | | | Nafion ® 117 | Nafion ® 117 |
| 56 (FEP | 6.2 | 7.3 | 30.8 | Tensile | Tensile |
| 0.127 | | | | strength > | strength > |
| mm) | | | | Nafion ® 117 | Nafion ® 117 |
| Nafion ® 117 | 7.4 | 8.6 | ˜50 | Clear | Clear |

The proton exchange membranes obtained in Examples 6 were tested for IEC, water-content and specify resistivity. A Nafion® 117 membrane was also tested for comparative purposes. The results of the aforementioned testing are summarized below in Table X.

TABLE X

| | IEC_{dry} | H₂O Content | Specific Resistivity* |
|---|---|---|---|
| Sample No. | (meq/g) | (dry basis, %) | (ohm-cm²) |
| 41 | 1.083 | 31.2 | 0.243 |
| 42 | 0.966 | 23.9 | 0.345 |
| 43 | 0.472 | 15.5 | 1.000+ |
| 44 | 0.159 | 1.4 | 1.000+ |
| 45 | 0.830 | 31.1 | 1.000+ |
| 46 | 0.977 | 27.3 | 1.000+ |
| 47 | 1.125 | 29.5 | 0.307 |
| 48 | 1.179 | 37.7 | 0.262 |
| Nafion ® 117 | 0.910 | 34.5 | 0.230 |

*contact pressure = 500 psi, bonded Pt black electrodes. Membranes in H⁺ form.

The physical characteristics of the samples of Table X were tested and are summarized below in Table XI.

TABLE XI

| | | | % Area | | |
|---|---|---|---|---|---|
| | Thickness | | Increase | Physical Characteristics | |
| | (mil)** | | (dry to | Before | After |
| Sample No. | Dry | Wet | wet) | Boiling | Boiling |
| 41 | 5.9 | 7.1 | 37.9 | Tensile | Tensile |
| 42 | 5.9 | 6.7 | 27.6 | strength | strength |
| | | | | greater than | greater than |
| | | | | Nafion ® 117 | Nafion ® 117 |
| 43 | 8.7 | 11.1 | 22.2 | Tensile | Tensile |
| 44 | 8.2 | 11.7 | 5.2 | strength | strength |
| | | | | greater than | greater than |
| | | | | Nafion ® 117 | Nafion ® 117 |
| | | | | (blister | (graft not |
| | | | | formation) | uniform; |
| | | | | | blister |
| | | | | | formation) |
| 45 | 10.1 | 12.9 | 10.3 | Tensile | Tensile |
| 46 | 9.6 | 11.6 | 12.5 | strength | strength |
| | | | | greater than | greater than |
| | | | | Nafion ® 117 | Nafion ® 117 |
| | | | | (blister | (graft not |
| | | | | formation) | uniform; |
| | | | | | blister |
| | | | | | formation) |
| 47 | 5.8 | 6.9 | 32.5 | Tensile | Tensile |
| 48 | 5.9 | 7.5 | 49.6 | strength | strength |
| | | | | greater than | greater than |
| | | | | Nafion ® 117 | Nafion ® 117 |
| Nafion ® 117 | 7.4 | 8.6 | ˜50 | Clear | Clear |

**Average of 5 or more point measurements

Blister formation was evident in samples with low S/DVB weight gains (e.g., samples 43 through 46) and is indicated by the increased thickness measurements shown. Samples with 14.4 to 16.4 wt % gain (e.g., samples 41, 42 and 48) were uniform in appearance and showed reproducible performance.

Table XII and XIII compare the performance characteristics and the physical characteristics, respectively, of the various samples of Table VIII.

TABLE XII

| | IEC_{dry} | H₂O Content | Specific Resistivity♭ |
|---|---|---|---|
| Sample No. | (meq/g) | (dry basis, %) | (ohm-cm²) |
| 47 | 1.125 | 29.5 | 0.307 |
| 48 | 1.179 | 37.7 | 0.262 |
| 41 | 1.083 | 31.2 | 0.243 |
| 42 | 0.966 | 23.9 | 0.345 |
| 49 | 1.125 | 34.1 | 0.287 |
| 50 | 0.897 | 25.1 | 0.291 |
| 51 | 0.711 | 25.4 | 0.407 |
| 52 | 0.668 | 20.1 | 0.357 |
| Nafion ® 117 | 0.910 | 34.5 | 0.230 |

♭Contact pressure = 500 psi, bonded Pt black electrodes. Membranes in H⁺ form.

TABLE XIII

| | | | % Area | | | |
|---|---|---|---|---|---|---|
| | Thickness | | Increase | Physical Characteristics | | |
| Sample | (mil)^{a} | | (dry to | Before | After | |
| No. | Dry | Wet | wet) | Boiling | Boiling | Dried^{b} |
| 47 | 5.8 | 6.9 | 32.5 | Tensile | Tensile | Tensile |
| 48 | 5.9 | 7.5 | 49.6 | strength > | strength > | strength < |
| 41 | 5.9 | 7.1 | 37.9 | Nafion ® | Nafion ® | Nafion ® |
| 42 | 5.9 | 6.7 | 27.6 | 117 | 117 | 117 |
| 49 | 6.0 | 7.15 | 36.7 | Tensile | Tensile | Tensile |
| 50 | 5.75 | 6.65 | 26.5 | strength > | strength > | strength < |
| 51 | 6.0 | 6.00 | 25.4 | Nafion ® | Nafion ® | Nafion ® |
| 52 | 6.0 | 6.70 | 24.2 | 117 | 117 | 117 |

| | | | | |
|---|---|---|---|---|
| Nafion ® | 7.4 | 8.6 | ˜50 | NA |
| 117 | | | | |

^{a}Dried for 3 hours at 90° C.
^{b}Average of 5 or more point measurements.

Samples fabricated in solutions in 1.5% S/DVB or higher were not as reproducible during large batch processing due to gelling of the polymerization solutions. The gelling limited the amount of the S/DVB and/or the uniformity in which the films were imbibed.

An examination of Table XII above shows a decrease in both the IEC and the water content and an increase in resistivity of the larger batch films, as compared to small batch fabrication. In addition, Table XII shows that the IEC, water content and resistivity of the large films prepared using 1% S/DVB and reacted for 16 hours have degraded, as compared to the properties of the small batch material. It is believed that this was due to a longer time for 5 liters of solution to reach 55° C., as compared to the 150 mL for the small batch. The times listed above are the immersion times of the films in solution, and not the time at temperature. Likewise, the film reacted for 14 hours was placed in a warm solution (it was placed in the same solution with the 16-hour processed membrane, only 2 hours later), with a resulting weight gain higher than that of the 14-hour, 150-mL reaction.

### EXAMPLE 9

### Direct Methanol Fuel Cell Testing

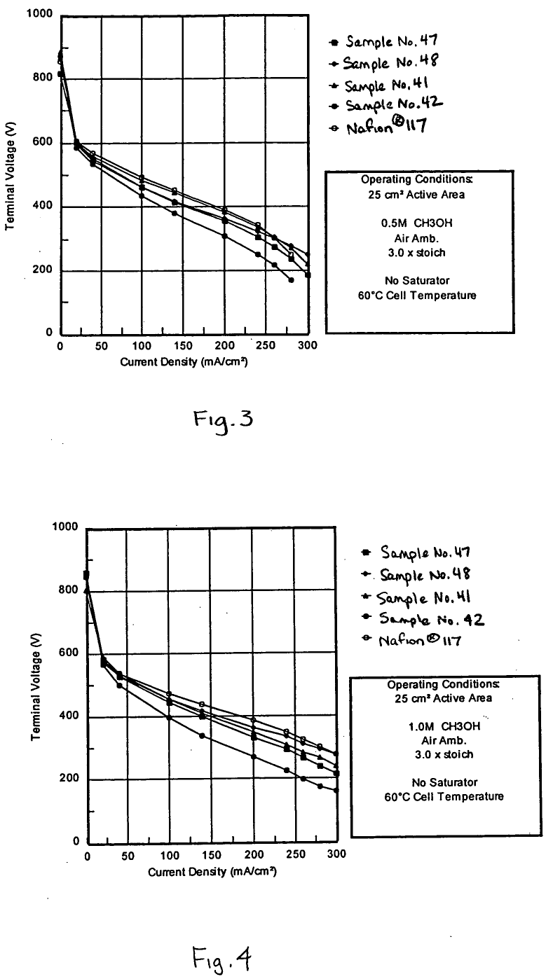

Four of the membranes from Table VII, namely, samples 47, 48, 41 and 42 were fabricated into complete MEAs by thermally bonding an anode and cathode to opposite sides of each membrane. The anodes consisted of 4 mg/cm² PtRu and the cathodes consisted of 4 mg/cm² Pt black. The MEAs were tested at 60° C. using both 0.5 methanol or 1.0 M methanol and air at atmospheric pressure. A direct comparison of the direct methanol fuel cell performance of each MEA using 0.5 M methanol (FIG. 3) and 1.0 M methanol (FIG. 4) is made to a Nafion® 117 MEA tested under identical fuel cell conditions.

As can be seen, the membranes exhibited fuel cell performance within 90 to 100% of that provided by the Nafion® 117 membrane at a current density of 100 mA/cm². In fact, the MEA containing sample 48 (sample 48 having been fabricated via a single 16-hour polymerization cycle in 1% S/DVB) exhibited ˜100% of the fuel cell performance obtained by Nafion® 117 when tested with 0.5 M methanol. The MEA containing sample 42 (sample 42 having been fabricated with a single polymerization cycle of 3 wt % S/DVB) exhibited the lowest performance but was still within 90% of the fuel cell performance obtained by Nafion® 117 at 100 mA/cm². The performance of the MEAs containing film samples 47 and 41 was between that of the previously discussed two films.

The above membranes were also evaluated for methanol exclusion properties. Methanol permeation through each membrane was measured with 0.5 and 1.0 M methanol concentrations. Methanol permeation through the above membranes was up to 87% lower than that of Nafion® 117 during operation at 100 mA/cm². At higher current densities, the methanol permeation rate through the above membranes was negligible.

### EXAMPLE 10

### Direct Methanol Fuel Cell Performance (Large Scale)

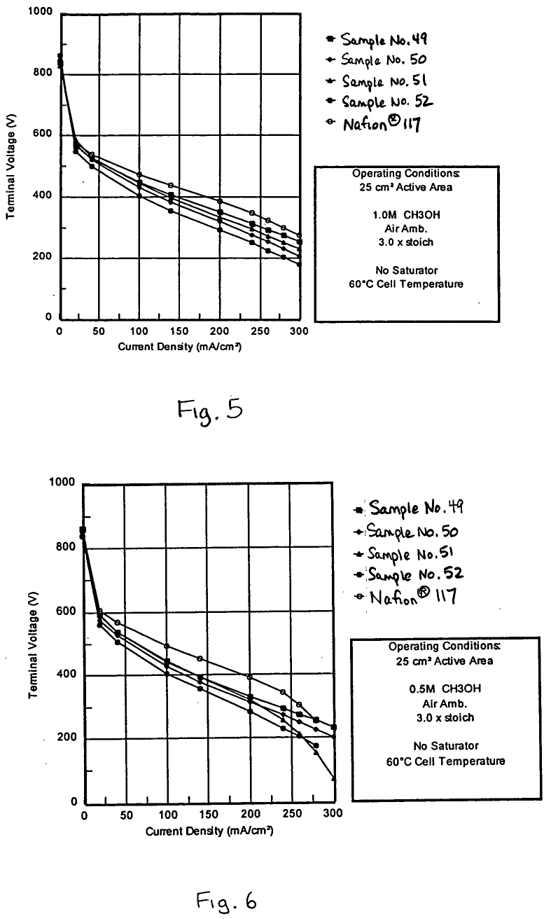

Membranes 49, 50, 51 and 52 were fabricated into MEAs in the same manner detailed above for membranes 47, 48, 41 and 42. A direct comparison of the direct methanol fuel cell performance of such MEAs to a Nafion® 117 MEA was made using 0.5 M methanol (FIG. 5) and 1.0 M methanol (FIG. 6).

Fuel cell performance of the small batch and large scale membranes was similar. Except for the small batch membranes fabricated with 3% S/DVB, performance at 100 mA/cm² was 94 to 98% of that provided by the Nafion® 117 membrane. Performance of the large scale membranes was 91 to 96% of that of the small batch membranes on 0.5 M methanol and was comparable on 1.0 M methanol.

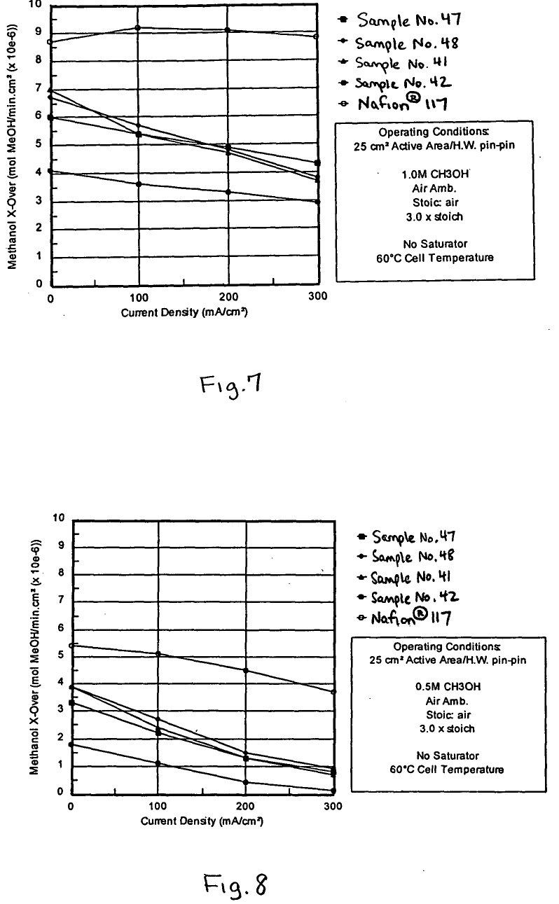

The methanol permeability through membranes prepared by the small batch and scaled-up batch processes was measured at methanol concentrations of 0.5 and 1.0M at open circuit (no current flow) conditions and at 100, 200, and 300 mA/cm². A comparison of methanol permeation during fuel cell operation for membranes prepared in small batches with 0.5 M methanol is shown in FIG. 7 and with 1.0 M methanol in FIG. 8. Data for both small and scaled-up batches are provided below in Tables XIV for 0.5 M methanol and XV for 1.0 M methanol.

TABLE XIV

| | CH₃OH Permeability | | | |
|---|---|---|---|---|
| | (moles CO₂ · | | Fuel Cell Performance | |
| | min⁻¹ · cm⁻²) × 10⁻⁶ | | (mV) | |
| | @ 0 | @ 100 | @ 100 | @ 200 |
| Sample No. | mAcm² | mA/cm² | mA/cm² | mA/cm² |
| 47 | 3.3 | 2.2 | 463 | 355 |
| 48 | 3.9 | 2.7 | 462 | 363 |
| 41 | 3.9 | 2.4 | 484 | 384 |
| 42 | 1.8 | 1.1 | 434 | 308 |
| 49 | 3.0 | 2.0 | 444 | 330 |
| 50 | 3.1 | 2.1 | 428 | 313 |
| 51 | 2.1 | 1.1 | 441 | 318 |
| 52 | 1.2 | 0.6 | 405 | 282 |
| Nafion ® 117 | 5.4 | 5.1 | 493 | 392 |

TABLE XV

| | CH₃OH Permeability | | | |
|---|---|---|---|---|
| | (moles CO₂ · | | Fuel Cell Performance | |
| | min⁻¹ · cm⁻²) × 10⁻⁶ | | (mV) | |
| | @ 0 | @ 100 | @ 100 | @ 200 |
| Sample No. | mAcm² | mA/cm² | mA/cm² | mA/cm² |
| 47 | 6.0 | 5.4 | 446 | 332 |
| 48 | 7.7 | 6.7 | 456 | 363 |
| 41 | 7.0 | 5.4 | 455 | 348 |
| 42 | 4.1 | 3.6 | 399 | 270 |
| 49 | 5.8 | 5.0 | 448 | 352 |
| 50 | 5.5 | 5.1 | 432 | 322 |
| 51 | 3.7 | 2.9 | 444 | 335 |
| 52 | 3.0 | 2.8 | 403 | 293 |
| Nafion ® | 8.7 | 9.2 | 475 | 387 |
| 117 | | | | |

Sample 42 exhibited the most significant reduction in methanol crossover with respect to Nafion® 117, namely, 60.9% during direct methanol fuel cell operation with 1.0 M and 78.4% with 0.5 M methanol at 100 mA/cm². At higher current densities, methanol crossover through this membrane was negligible, i.e., 91.1% reduction in methanol crossover at 200 mA/cm² and 97.3% reduction at 300 mA/cm² as compared to Nafion® 117. As shown in FIGS. 7 and 8, the methanol exclusion of the remaining membranes was 40% to 60% lower than the Nafion® 117 membrane.

### EXAMPLE 11

### Life Tests

Life tests at current densities of 100 mA/cm² were used to determine the stability of the membrane of the present invention for extended periods of operation. Two different membranes fabricated in the above manner performed similarly. The fuel cell performance at 100 mA/cm² averaged 420 mV, or within −95% of that obtained by Nafion® 117 MEAs. One membrane was tested for 40 hours, and the other membrane was tested for a period of over 120 hours. For both membranes, stable performance was obtained over the course of the life tests.

The embodiments of the present invention recited herein are intended to be merely exemplary and those skilled in the art will be able to make numerous variations and modifications to it without departing from the spirit of the present invention. All such variations and modifications are intended to be within the scope of the present invention as defined by the claims appended hereto.

What is claimed is:

1. A proton exchange membrane well-suited for use in a direct organic fuel cell, said proton exchange membrane being prepared by a process comprising the steps of:
(a) providing a perfluorocarbon membrane, said perfluorocarbon membrane being non-permeable to water;
(b) imbibing said perfluorocarbon membrane with a polymerizable monomer and a cross-linker;
(c) effecting the cross-linked polymerization of said polymerizable monomer to yield a cross-linked polymer within said perfluorocarbon membrane;
(d) repeating the combination of steps (b) and (c) at least once; and
(e) then, sulfonating the cross-linked polymer.

2. The proton exchange membrane as claimed in claim 1 wherein said perfluorocarbon membrane is a film selected from the group consisting of a fluorinated ethylene propylene film and a polytetrafluoroethylene film.

3. The proton exchange membrane as claimed in claim 2 wherein said perfluorocarbon membrane is a fluorinated ethylene propylene film.

4. The proton exchange membrane as claimed in claim 3 wherein said perfluorocarbon membrane has a thickness of about 0.051 to 0.127 mm.

5. The proton exchange membrane as claimed in claim 4 wherein said perfluorocarbon membrane has a thickness of about 0.051 mm.

6. The proton exchange membrane as claimed in claim 4 wherein said perfluorocarbon membrane has a thickness of about 0.127 mm.

7. The proton exchange membrane as claimed in claim 1 wherein said polymerizable monomer is a styrene monomer.

8. The proton exchange membrane as claimed in claim 1 wherein said cross-linker is a divinyl benzene.

9. The proton exchange membrane as claimed in claim 1 wherein said imbibing step comprises immersing said perfluorocarbon membrane in a solution comprising styrene and divinyl benzene.

10. The proton exchange membrane as claimed in claim 9 wherein said solution comprises about 1-8%, by weight, divinyl benzene with respect to styrene.

11. The proton exchange membrane as claimed in claim 10 wherein said solution further comprises about 1%, by weight, benzoyl peroxide as an activator.

12. The proton exchange membrane as claimed in claim 1 wherein the combination of steps (b) and (c) is repeated between one and four times.

13. The proton exchange membrane as claimed in claim 12 wherein said imbibing step comprises immersing said perfluorocarbon membrane in a solution comprising styrene and divinyl benzene, wherein divinyl benzene is present in said solution in an amount constituting about 1-8 wt % of styrene and wherein the concentration of divinyl benzene relative to styrene is greater in later repetitions of said imbibing step than in earlier repetitions of said imbibing step.

14. The proton exchange membrane as claimed in claim 13 wherein said imbibing step is repeated three times and wherein divinyl benzene is present in said solution in an amount constituting about 1 wt % relative to styrene for the first three imbibing steps and in an amount constituting about 3-8 wt % relative to styrene for the fourth imbibing step.

15. The proton exchange membrane as claimed in claim 11 wherein said effecting step comprises heating the imbibed perfluorocarbon membrane at 60-90° C. for a period of about 16 hours.

16. The proton exchange membrane as claimed in claim 1 wherein said process further comprises, before said imbibing step, the step of irradiating the perfluorocarbon membrane.

17. A method of preparing a proton exchange membrane, the proton exchange membrane being well-suited for use in a direct organic fuel cell, said method comprising the steps of:
(a) providing a perfluorocarbon membrane, said perfluorocarbon membrane being non-permeable to water;
(b) imbibing said perfluorocarbon membrane with a polymerizable monomer and a cross-linker;
(c) effecting the cross-linked polymerization of said polymerizable monomer to yield a cross-linked polymer within said perfluorocarbon membrane;
(d) repeating the combination of steps (b) and (c) at least once; and
(e) then, sulfonating the cross-linked polymer.

18. The method as claimed in claim 17 wherein said polymerizable monomer is styrene, wherein said cross-linker is divinyl benzene and wherein said imbibing step comprises immersing said perfluorocarbon membrane in a solution comprising styrene and divinyl benzene.

19. The method as claimed in claim 18 wherein said solution comprises about 1-8%, by weight, divinyl benzene with respect to styrene.

20. The method as claimed in claim 17 wherein the combination of steps (b) and (c) is repeated between one and four times.

21. The method as claimed in claim 17 wherein said imbibing step comprises immersing said perfluorocarbon membrane in a solution comprising styrene and divinyl benzene, wherein divinyl benzene is present in said solution in an amount constituting about 1-8 wt % of styrene and wherein the concentration of divinyl benzene relative to styrene is greater in later repetitions of said imbibing step than in earlier repetitions of said imbibing step.

22. The method as claimed in claim 21 wherein said imbibing step is repeated three times and wherein divinyl benzene is present in said solution in an amount constituting about 1 wt % relative to styrene for the first three imbibing steps and in an amount constituting about 3-8 wt % relative to styrene for the fourth imbibing step.

23. The method as claimed in claim 17 further comprising, before said imbibing step, the step of irradiating the perfluorocarbon membrane.

24. A membrane electrode assembly comprising:
(a) the proton exchange membrane as claimed in claim 1;
(b) an anode, said anode being positioned against a first face of said proton exchange membrane; and
(c) a cathode, said cathode being positioned against a second face of said proton exchange membrane, said second face opposing said first face.

25. A proton exchange membrane well-suited for use in a direct organic fuel cell, said proton exchange membrane being prepared by a process comprising the steps of:
(a) providing a perfluorocarbon membrane, said perfluorocarbon membrane being non-permeable to water;
(b) imbibing said perfluorocarbon membrane with a polymerizable monomer and a cross-linker;
(c) effecting the cross-linked polymerization of said polymerizable monomer to yield a cross-linked polymer within said perfluorocarbon membrane; and
(d) then, sulfonating the cross-linked polymer.

26. A proton exchange membrane well-suited for use in a direct organic fuel cell, said proton exchange membrane being prepared by a process comprising the steps of:
(a) providing a membrane, said membrane being a non-water-permeable polymer, copolymer or terpolymer membrane formed from hydrocarbon, halogenated or perhalogenated monomers;
(b) irradiating said membrane so as to render said membrane receptive to the grafting of a polymer thereto;
(c) imbibing said membrane with a polymerizable monomer and a cross-linker;
(d) effecting the cross-linked polymerization of said polymerizable monomer and the grafting of said cross-linked polymer to said membrane; and
(e) then, sulfonating the cross-linked polymer.

27. The proton exchange membrane as claimed in claim 26 wherein said membrane is made of a material selected from the group consisting of polyethylene (PE), polytetrafluoroethylene (PTFE), polyhexafluoropropylene (HEP), tetrafluoroethylene-hexafluoropropylene copolymer (FEP), tetrafluoroethylene-propylene copolymer, tetrafluoroethylene-ethylene copolymer (ETFE), hexafluoropropylene-propylene copolymer, hexafluoropropylene-ethylene copolymer, polyvinylidene fluoride (PVDF), vinylidene fluoride tetrafluoroethylene copolymer (PVDF-TFE), vinylidene fluoride hexafluoropropylene copolymer (PVDF-HFP or “Kynar-Flex”), polyvinyl fluoride, tetrafluoroethylene-perfluoroalkyl vinyl ether copolymer, polyvinylidene-hexafluoropropylene copolymer, chlorotrifluoroethylene-ethylene copolymer, chlorotrifluoroethylene-propylene-propylene copolymer, perfluoroalkoxy copolymer, polychloroethylene, polyvinyl fluoride, tetrafluoroethylene-perfluoroalkyl vinyl ether copolymer, or perfluoroalkoxy copolymer (PFA).

28. The proton exchange membrane as claimed in claim 27 wherein said membrane is a fluorinated ethylene propylene film.

29. The proton exchange membrane as claimed in claim 28 wherein said membrane has a thickness of about 0.051 to 0.127 mm.

30. The proton exchange membrane as claimed in claim 29 wherein said membrane has a thickness of about 0.051 mm.

31. The proton exchange membrane as claimed in claim 29 wherein said membrane has a thickness of about 0.127 mm.

32. The proton exchange membrane as claimed in claim 26 wherein said polymerizable monomer is selected from the group consisting of styrene, trifluorostyrene, alpha,methylstyrene, alpha,beta-dimethylstyrene, alpha,beta,beta-trimethylstyrene, ortho-methylstyrene, meta-methylstyrene and paramethylstyrene.

33. The proton exchange membrane as claimed in claim 26 wherein said polymerizable monomer is styrene.

34. The proton exchange membrane as claimed in claim 26 wherein said cross-linker is selected from the group consisting of divinyl benzene and triallylcyanurate.

35. The proton exchange membrane as claimed in claim 26 wherein said cross-linker is divinyl benzene.

36. The proton exchange membrane as claimed in claim 26 wherein said imbibing step comprises immersing said membrane in a solution comprising styrene, divinyl benzene and benzoyl peroxide.

37. The proton exchange membrane as claimed in claim 36 wherein said solution comprises about 1-8%, by weight, divinyl benzene with respect to styrene.

38. The proton exchange membrane as claimed in claim 37 wherein said solution comprises about 1%, by weight, benzoyl peroxide.

39. The proton exchange membrane as claimed in claim 36 wherein said cross-linked polymer represents a weight gain of about 14-16% for said membrane.

40. The proton exchange membrane as claimed in claim 26 wherein said imbibing step ranges from 6-30 hours in length.

41. The proton exchange membrane as claimed in claim 40 wherein said imbibing step ranges from 15-18 hours in length.

42. The proton exchange membrane as claimed in claim 26 wherein said imbibing step is conducted at about 35° C.-80° C.

43. The proton exchange membrane as claimed in claim 42 wherein said imbibing step is conducted at 55° C.-60° C.

44. The proton exchange membrane as claimed in claim 26 wherein said irradiating step is performed using at least one of an electron beam, gamma rays, X-rays, UV light, plasma irradiation and beta particles.

45. The proton exchange membrane as claimed in claim 44 wherein said irradiating step is performed using beta particles.

46. The proton exchange membrane as claimed in claim 26 wherein said irradiating step comprises irradiating the membrane with a radiation dose in the range of about 0.1 kGray to 500 kGray.

47. The proton exchange membrane as claimed in claim as claimed in claim 46 wherein said radiation dose is in the range of about 20-50 kGray.

48. The proton exchange membrane as claimed in claim 26 wherein after said irradiating step and prior to said imbibing step, said perfluorocarbon membrane is stored in a cold, inert atmosphere for up to 3 months.

49. A method of preparing a proton exchange membrane, the proton exchange membrane being well-suited for use in a direct organic fuel cell, said method comprising the steps of:
(a) providing a membrane, said membrane being a non-water-permeable polymer, copolymer or terpolymer membrane formed from hydrocarbon, halogenated or perhalogenated monomers;
(b) irradiating said membrane so as to render said membrane receptive to the grafting of a polymer thereto;
(c) imbibing said membrane in a solution comprising a polymerizable monomer and a cross-linker;
(d) effecting the cross-linked polymerization of said polymerizable monomer and the grafting of said cross-linked polymer to said membrane; and
(e) then, sulfonating the cross-linked polymer.

50. The method as claimed in claim 49 wherein said polymerizable monomer is styrene, wherein said cross-linker is divinyl benzene and wherein said imbibing step comprises immersing said membrane in a solution comprising styrene, divinyl benzene and benzoyl peroxide.

51. The method as claimed in claim 49 wherein after said irradiating step and prior to said imbibing step, said membrane is stored in a cold, inert atmosphere for up to 3 months.

52. A membrane electrode assembly comprising:
(a) the proton exchange membrane as claimed in claim 26;
(b) an anode, said anode being positioned against a first face of said proton exchange membrane; and
(c) a cathode, said cathode being positioned against a second face of said proton exchange membrane, said second face opposing said first face.

53. A method for treating a non-water-permeable perfluorocarbon membrane so as to render said non-water-permeable perfluorocarbon membrane receptive to being imbibed with a polymerizable monomer, an activator and a cross-linker and thereafter having uniform polymerization, crosslinking and grafting within said non-water-permeable perfluorocarbon membrane, said method comprising the step of irradiating the non-water-permeable perfluorocarbon membrane.

54. The method as claimed in claim 53 wherein said irradiating step is performed using at least one of an electron beam, gamma rays, X-rays, UV light, plasma irradiation and beta particles.

55. The method as claimed in claim 54 wherein said irradiating step is performed using beta particles.

56. The method as claimed in claim 53 wherein said irradiating step comprises irradiating the non-water-permeable perfluorocarbon membrane with a radiation dose in the range of about 0.1 kGray to 500 kGray.

57. The method as claimed in claim as claimed in claim 56 wherein said radiation dose is in the range of about 20-50 kGray.

58. A method of preparing a proton exchange membrane, the proton exchange membrane being well-suited for use in a direct organic fuel cell, said method comprising the steps of:
(a) providing a perfluorocarbon membrane, said perfluorocarbon membrane being non-permeable to water;
(b) imbibing said perfluorocarbon membrane with a polymerizable monomer;
(c) effecting the polymerization of said polymerizable monomer to yield a polymer within said perfluorocarbon membrane;
(d) then, imbibing said perfluorocarbon membrane with a cross-linker;
(e) then, effecting the cross-linked polymerization of said polymer to yield a cross-linked polymer; and
(f) then, sulfonating the cross-linked polymer.

59. The method as claimed in claim 58 wherein the combination of steps (b) through (e) is repeated at least once.

60. A method of preparing a proton exchange membrane, the proton exchange membrane being well-suited for use in a direct organic fuel cell, said method comprising the steps of:
(a) providing a membrane, said membrane being a non-water-permeable polymer, copolymer or terpolymer membrane formed from hydrocarbon, halogenated or perhalogenated monomers;
(b) irradiating said membrane so as to render said membrane receptive to the grafting of a polymer thereto;
(c) imbibing said membrane with a polymerizable monomer;
(d) then, effecting the polymerization of said polymerizable monomer and the grafting of said polymer to said membrane;
(e) then, imbibing said membrane with a cross-linker;
(f) then, effecting the cross-linked polymerization of said polymer to yield a cross-linked polymer; and
(g) then, sulfonating the cross-linked polymer.
